(19) United States
(12) Patent Application Publication
(10) Pub. No.: US 2024/0312364 A1
(43) Pub. Date: Sep. 19, 2024

(54) SYSTEMS AND METHODS FOR SPORTS AND MOVEMENT TRAINING

(71) Applicant: BOOSTA, INC., Long Beach, CA (US)

(72) Inventors: Timothy Brian DONNELLY, Long Beach, CA (US); Shelby Christopher ERICKSON, Long Beach, CA (US); Jonathan Isaac STRIETZEL, Lakewood, CA (US); Zach Tyler BATTLEMAN, West Harrison, NY (US)

(21) Appl. No.: 18/638,370

(22) Filed: Apr. 17, 2024

Related U.S. Application Data
(63) Continuation of application No. 17/743,976, filed on May 13, 2022.
(60) Provisional application No. 63/189,040, filed on May 14, 2021.
(60) Provisional application No. 63/189,043, filed on May 14, 2021.
(60) Provisional application No. 63/189,045, filed on May 14, 2021.
(60) Provisional application No. 63/189,047, filed on May 14, 2021.
(60) Provisional application No. 63/189,049, filed on May 14, 2021.
(60) Provisional application No. 63/189,052, filed on May 14, 2021.

(51) Int. Cl. G09B 19/00; A63B 71/06; G06T 7/20; G06T 7/70; G06T 11/60; G06V 20/40; G06V 40/10; G10L 15/22; G10L 15/26; G10L 25/57

(52) U.S. Cl. CPC G09B 19/0038; A63B 71/0622; G06T 7/20; G06T 7/70; G06T 11/60; G06V 20/41; G06V 40/10; G10L 15/22; G10L 15/26; G10L 25/57; A63B 2071/0625; A63B 2071/0638; A63B 2071/0694; G06T 2207/10016; G06T 2207/30196

(57) ABSTRACT

A platform for interactive sports and movement training is disclosed. The platform allows a trainer to: upload a step-by-step training video for a challenge via a trainer user interface for access by a plurality of trainees; receive videos of individual trainees performing the steps of the training video; provide feedback to the trainees regarding how they can improve their performance associated with each of the steps of the training video; and indicate when a trainee can access a next step in the step-by-step training, until all movements have been mastered. The platform allows a user to access a first step of a step-by-step training video via a user interface; upload a video of the user performing the first step; receive feedback, via the user interface, from a trainer; and when the feedback indicates that the user is ready, access a next step of the training video.

### RELATED APPLICATIONS INFORMATION

The present application is a continuation of U.S. application Ser. No. 17/743,976, filed May 13, 2022, and claims the benefit of priority under 35 U.S.C. 119(c) to Provisional Patent Application Ser. No. 63/189,040, entitled “SYSTEMS AND METHODS FOR A USER INTERFACE FOR SPORTS AND MOVEMENT TRAINING”, filed May 14, 2021, to Provisional Patent Application Ser. No. 63/189,043, entitled “SYSTEMS AND METHODS FOR A TRAINER USER INTERFACE FOR SPORTS AND MOVEMENT TRAINING”, filed May 14, 2021, to Provisional Patent Application Ser. No. 63/189,045, entitled “SYSTEMS AND METHODS FOR A PLATFORM AND DATABASE FOR SPORTS AND MOVEMENT TRAINING”, filed May 14, 2021, to Provisional Patent Application Ser. No. 63/189,047, entitled “SYSTEMS AND METHODS FOR AUTOMATIC FEEDBACK FOR SPORTS AND MOVEMENT TRAINING WITH KEY EVENT DETECTION AND FEEDBACK”, filed May 14, 2021, to Provisional Patent Application Ser. No. 63/189,049, entitled “SYSTEMS AND METHODS FOR GENERATING AN OVERLAY FOR AUTOMATIC FEEDBACK FOR SPORTS AND MOVEMENT TRAINING USING AN OVERLAY”, filed May 14, 2021, and to Provisional Patent Application Ser. No. 63/189,052, entitled “SYSTEMS AND METHODS FOR AUTOMATIC FEEDBACK FOR SPORTS AND MOVEMENT TRAINING INCORPORATING SENSOR DATA”, filed May 14, 2021, each of which is incorporated herein by reference as if set forth in full.

### TECHNICAL FIELD

The embodiments described herein are generally directed to a platform for interactive movement training and, more particularly, to a platform for interactive sports training and for the development and maintenance of a database and reporting related thereto.

### BACKGROUND

Operators in the Sports Coaching industry have performed well over the majority of the five years from 2015 to 2020, with industry revenue expected to grow at an annualized rate of 1.0% to $8.9 billion during the current period. High sports participation and rising per capita disposable income levels have supported demand for industry services. In addition to these factors, the rising cost of attending college has encouraged some parents to invest in sports coaching for their children through camps and academies to increase their likelihood of receiving a scholarship. Furthermore, large salaries earned by professional athletes have led consumers to use industry services to increase their chances of making it to the professional ranks.

This industry includes one-on-one sports training at athletic facilities as well as camps and schools that offer instruction in athletic activities to groups or individuals. Overnight and day sports instruction camps are also included in this industry.

While large camps, academies, teams, and leagues may have advanced IoT and analytics tools available to them to aid in training, the typical trainer may not have such resources available. Moreover, even where available, such tools require the trainer and the trainee to be at the same location. The data may be available, e.g., through the cloud, but actually training based on the data requires the trainer and trainee to be physically together. As a result, a given trainer's ability to scale their business can be limited.

### SUMMARY

Accordingly, systems, methods, and non-transitory computer-readable media are disclosed to provide remote, interactive step-by-step training through and application and platform and to provide a database and reporting related thereto.

According to one aspect, a user system comprises at least one hardware processor; and one or more software modules that are configured to, when executed by the at least one hardware processor, provide a user interface; allow a user to access a step-by-step training video for a challenge from a training platform via the user interface; present the step-by-step training video via the user interface; allow the user to play a video illustrating the entire challenge through the user interface; allow the user to access a first step of the challenge and play video, via the user interface, illustrating a first movement of the challenge and record a video of user performing the first movement, receive feedback, via the user interface, from a trainer; when the feedback indicates the user is ready, allow the user to access a next step of the challenge and play video, via the user interface, illustrating a first movement of the challenge and record a video of user performing the first movement, receive feedback, via the user interface, from a trainer, until all movements have been mastered.

According to one aspect, a user system comprising: at least one hardware processor; and one or more software modules that are configured to, when executed by the at least one hardware processor, provide a user interface; allow a user to upload a step-by-step training video for a challenge to a training platform via the user interface for access by a plurality of trainces; receive via the user interface videos of each of the plurality of trainees performing the steps of the training video; provide feedback to each of the plurality of users regarding how they can improve their performance of movements associated with each of the steps of the training video; indicate when a user can access the next step in the step-by-step training until all movements have been mastered.

According to one aspect, a training platform comprising: at least one hardware processor; and one or more software modules that are configured to, when executed by the at least one hardware processor, provide a trainer user interface; allow a user to upload a step-by-step training video for a challenge to a training platform via the trainer user interface for access by a plurality of trainees; receive via the user interface videos of each of the plurality of trainees performing the steps of the training video; provide feedback to each of the plurality of users regarding how they can improve their performance of movements associated with each of the steps of the training video; indicate when a user can access the next step in the step-by-step training until all movements have been mastered provide a trainee user interface; allow a user to access a step-by-step training video for a challenge from a training platform via the trainee user interface; present the step-by-step training video via the trainee user interface; allow the user to play a video illustrating the entire challenge through the trainee user interface; allow the user to access a first step of the challenge and play video, via the trainee user interface, illustrating a first movement of the challenge and record a video of user performing the first movement, receive feedback, via the trainee user interface, from a trainer; when the feedback indicates the user is ready, allow the user to access a next step of the challenge and play video, via the traince user interface, illustrating a first movement of the challenge and record a video of user performing the first movement, receive feedback, via the trainee user interface, from a trainer, until all movements have been mastered.

According to one aspect, a user system comprising: at least one hardware processor; and one or more software modules that are configured to, when executed by the at least one hardware processor, provide a user interface; allow a user to upload a step-by-step training video for a challenge to a training platform via the user interface for access by a plurality of trainees; receive via the user interface videos of each of the plurality of trainees performing the steps of the training video; generate an overlay for the trainee in the video; detect key events in the video; compare the body position of the trainee for the key events in the video to a target event model; generate an annotation based on the comparison; overlay the annotation on the video as feedback; and provide the feedback to each of the plurality of users regarding how they can improve their performance of movements associated with each of the steps of the training video.

According to one aspect, a user system comprising: at least one hardware processor; and one or more software modules that are configured to, when executed by the at least one hardware processor, provide a user interface; allow a user to upload a step-by-step training video for a challenge to a training platform via the user interface for access by a plurality of trainees; receive via the user interface videos of each of the plurality of trainees performing the steps of the training video; generate an overlay for the trainee in the video, wherein generating an overlay comprises: uploading the video, detecting the trainee in the video and isolating the traince, creating a heat map of the trainer, building a skeleton, and rendering the skeleton over the trainee in the video; detect key events in the video; compare the body position of the trainee for the key events in the video to a target event model; generate an annotation based on the comparison; overlay the annotation on the video as feedback; and provide the feedback to each of the plurality of users regarding how they can improve their performance of movements associated with each of the steps of the training video.

According to one aspect, A user system comprising: at least one hardware processor; and one or more software modules that are configured to, when executed by the at least one hardware processor, receive video of multiple people performing movements, receive information that can be used to identify a specific person and track their movements and position, use computer vision to track the movements and positions of the people.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates a user interface that can be provided by a user system included in the infrastructure of FIG. 1, according to an embodiment;

FIG. 4 illustrates various plans that can be offered through the infrastructure of FIG. 1, according to an embodiment;

FIG. 5 illustrates the benefits to trainers of using the infrastructure of FIG. 1.

FIG. 6 illustrates an example of feedback that can be provided to a trainee using the infrastructure of FIG. 1;

FIG. 7 is a diagram illustrating how the infrastructure of FIG. 1 can be configured to provide automatic feedback to a trainee, according to an embodiment; and

FIG. 8 is a diagram illustrating how an overlay can be generated in order to generate automatic feedback using the infrastructure of FIG. 1, in accordance with one embodiment.

### DETAILED DESCRIPTION

In an embodiment, systems, methods, and non-transitory computer-readable media are disclosed for remote, interactive step-by-step training. One-on-one feedback can be provided, and a database for each trainee and for a specific trainer can be maintained, allowing the trainer to pull up reports for each trainee and for the practice overall. Moreover, AI/ML algorithms can be used to evaluate trainee data and provide the trainer and/or the trainee suggested modifications.

After reading this description, it will become apparent to one skilled in the art how to implement various alternative embodiments and alternative implementations of the embodiments described. Thus, although various embodiments will be described herein, it is understood that these embodiments are presented by way of example and illustration only, and not limitation. As such, this detailed description of various embodiments should not be construed to limit the scope or breadth of the appended claims. It should also be noted that while the embodiments described herein are directed to sports training, the same principals can be used for other movement training such as strength training, stretching, physical therapy, even knitting, etc. Basically, any type of activity that requires mastering a series of individual movements.

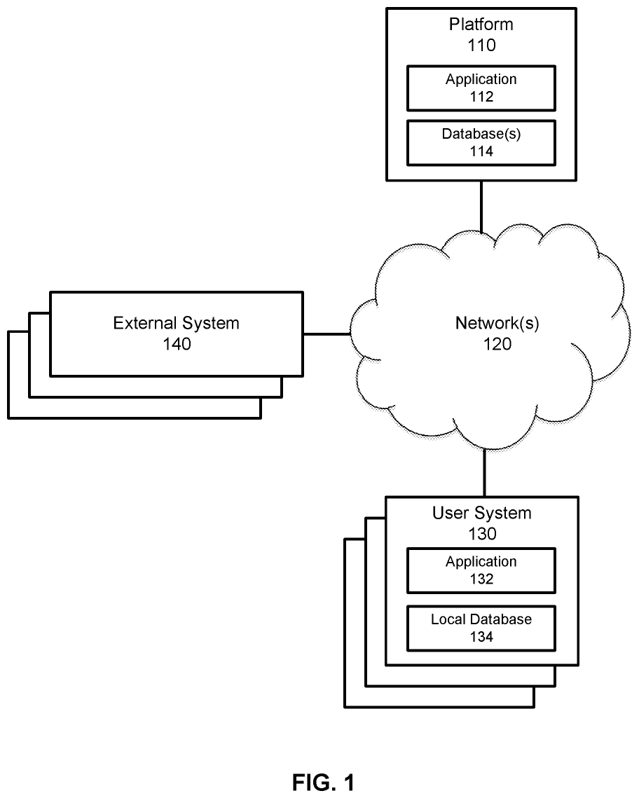

FIG. 1 illustrates an example infrastructure in which one or more of the disclosed processes may be implemented, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, Automated Teller Machines, and/or the like.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130 or server application 112 executing on platform 110 may submit data (e.g., user data, form data, etc.) to be stored in database(s) 114, and/or request access to data stored in database(s) 114. Any suitable database may be utilized, including without limitation MySQL™, Oracle™, IBM™, Microsoft SQL™, Access™, PostgreSQL™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in extensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132 executing on one or more user system(s) 130 may interact with a server application 112 executing on platform 110 to execute one or more or a portion of one or more of the various functions, processes, methods, and/or software modules described herein. Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the application described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules that implement one or more of the processes, methods, or functions of the application described herein.

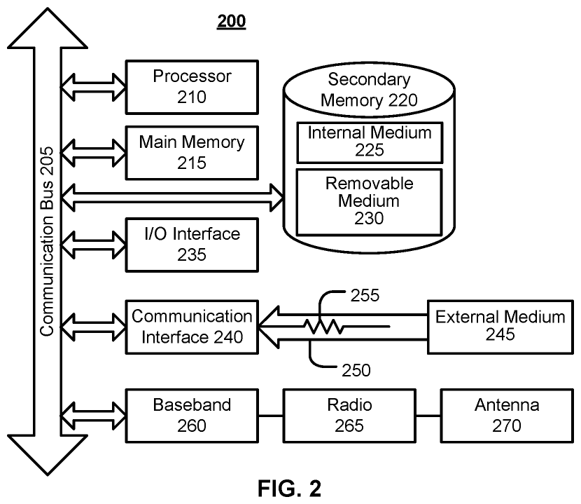

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the application or one or more software modules of the application) described herein, and may represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors, such as processor 210. Additional processors may be provided, such as an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, the Pentium® processor, Core i7® processor, and Xeon® processor, all of which are available from Intel Corporation of Santa Clara, California.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 preferably includes a main memory 215 and may also include a secondary memory 220. Main memory 215 provides storage of instructions and data for programs executing on processor 210, such as one or more of the functions and/or modules discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

Secondary memory 220 is a non-transitory computer-readable medium having computer-executable code (e.g., disclosed software modules) and/or other data stored thereon. The computer software or data stored on secondary memory 220 is read into main memory 215 for execution by processor 210.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 may include an external hard disk drive, an external optical drive, an external magneto-optical drive, and/or the like. Other examples of secondary memory 220 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed application, or software modules) is stored in main memory 215 and/or secondary memory 220. Computer programs can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable media are means for providing executable code, programming instructions, software, and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor 210, which may be a central processing unit (CPU). Processor 210 has access to data storage areas 215 and 220. Processor 210 is preferably configured to execute instructions (i.e., computer programs, such as the disclosed application, or software modules) that can be stored in main memory 215 or secondary memory 220. Computer programs can also be received from baseband processor 260 and stored in main memory 210 or in secondary memory 220, or executed upon receipt. Such computer programs, when executed, enable system 200 to perform the various functions of the disclosed embodiments.

Embodiments of processes for remote, interactive step-by-step training will now be described in detail. It should be understood that the described processes may be embodied in one or more software modules that are executed by one or more hardware processors (e.g., processor 210), for example, as the application discussed herein (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the application are executed by platform 110 and other portions or modules of the application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processors 210. In addition, the disclosed application may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

As can be seen in FIG. 1, an application 132 can be downloaded onto a user's system 130, such as a user's phone or tablet that allows them to log-on, after setting up an account with platform 110, and select a trainer(s). A trainer, after registering with platform 110, can upload step-by-step training videos and instruction. The step-by-step videos can illustrate individual steps, or movements that comprise a full “challenge”. Thus, application 132 can present to the trainee a user interface on user system 130 that allows the trainee to access the training videos uploaded by the trainer(s) to which the trainee has subscribed. The trainee can also capture video of themselves performing the steps or movements and upload the video(s) to the platform 110 via the user interface and user system 130.

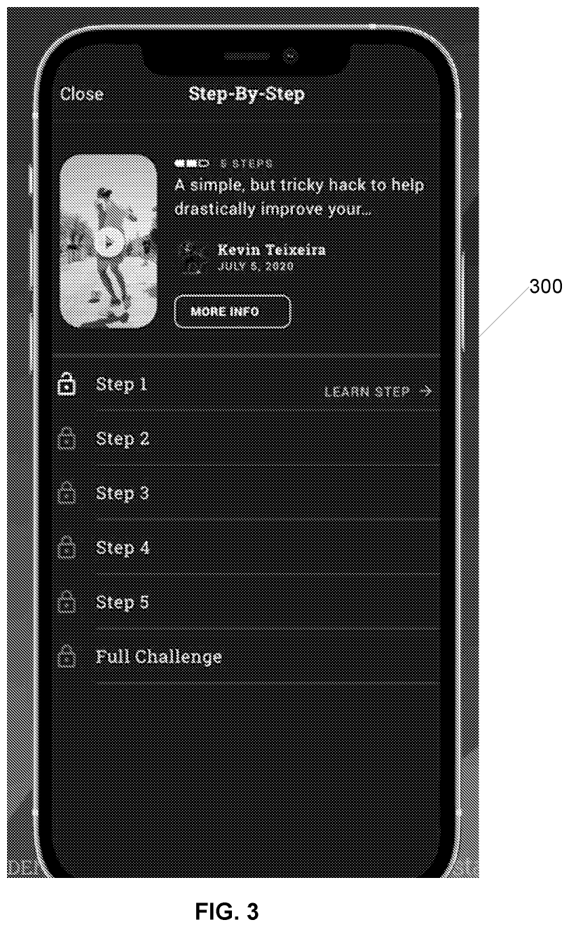

An example user interface 300, which may be part of the User System 130 of FIG. 1, is illustrated in FIG. 3. As can be seen, the trainee can access the step-by-step training module for a new challenge with information related to the challenge. The training module can be broken down by steps, in the case steps 1-5. For example, the trainee can initially have access only to step 1 and can play a video that illustrates for them how to perform the first movement of the challenge (step 1). The trainee can practice the step, rewind and re-watch the step, continue practicing, and ultimately upload (stream in real-time or upload at a later time) to platform 110 a video of themselves performing the step. The trainer can access platform 110 using the trainer's user system 130 in order to access the trainee video, which can be stored in database 114. The trainer can then review the trainee video and provide feedback through platform 110 to the trainee's user system 130. The trainee can then modify their performance of step 1 based on the feedback if required, and upload a new video of their performance of step 1, if necessary.

Once the trainer has determined that the trainee has mastered step 1, the trainer can cause step 2 to be unlocked and the process can continue, until the trainee is capable of performing the full challenge. It should be noted that the trainer can be viewing the trainee in real-time and providing feedback as the trainee attempts to master a step.

It should also be noted that in certain embodiments, the trainee's performance of the various steps can be evaluated automatically, e.g., algorithms or routines executed by application 112 on platform 110 can review the trainer video, review the trainee video and determine if the trainee's movement adequately approaches the trainer's movement.

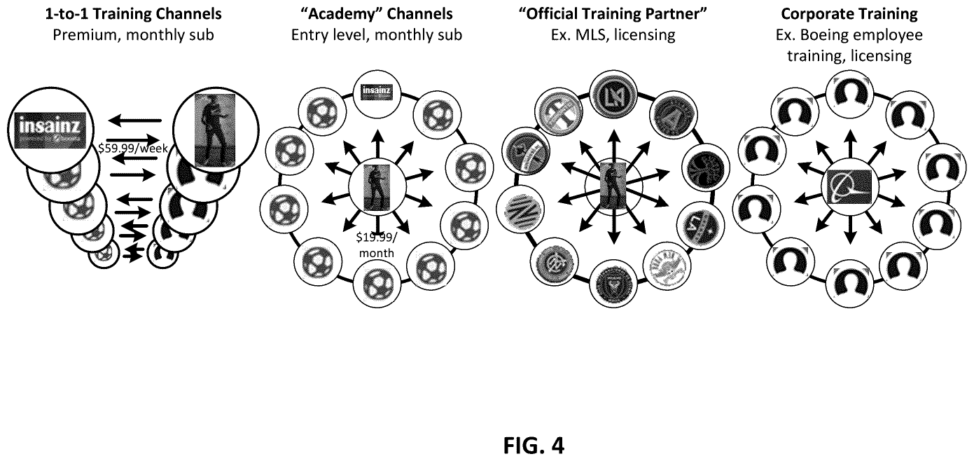

FIG. 4 illustrates various plans that can be offered through the infrastructure of FIG. 1, according to an embodiment. As noted, a trainee can sign up for one-to-one training with a trainer (e.g., “1-to-1 Training Channels”). Alternatively, a trainer can offer an academy style training where a group or team can train together (e.g., “Academy channels”). More B-to-B offerings can also be provided via platform 110, such as partnering with a team or league (e.g., “Official Training Partner”), or with a corporate entity, through which individuals can, e.g., sign up for individual or group training.

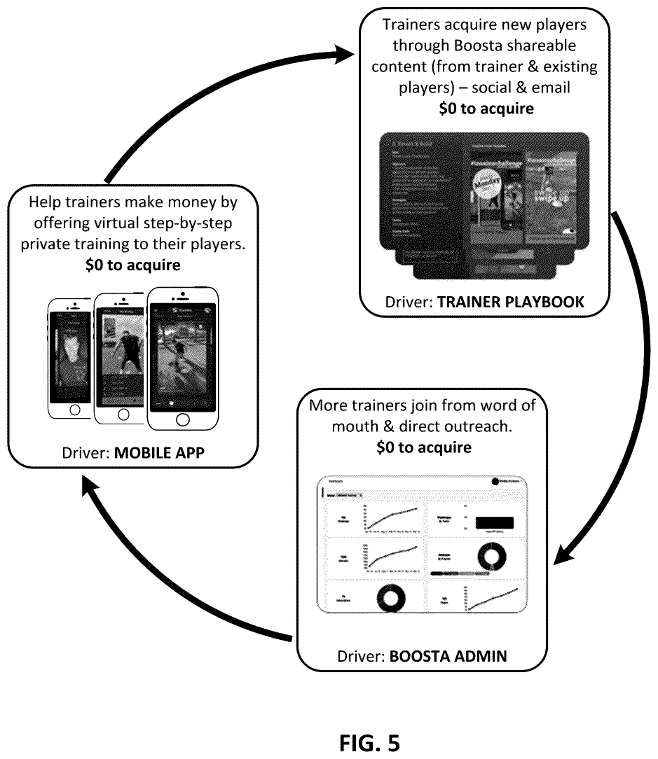

As illustrated in FIG. 5, there are numerous benefits to trainers provided by platform 110. For example, the platform 110 can help trainers (i) offer virtual step-by-step private training to their trainees and (ii) acquire new players by having their content shared through the platform 110 via social media, email, etc. (e.g., by the trainers themselves or by existing players on the platform). One benefit is that the videos, feedback and progress of trainees can be stored in database 114. As such, platform 110 can provide trainers reports that can help them improve their training and increase their business. For example, a trainer can see how often and how much trainees interact with the trainer's content. This can help the trainer understand what content is driving interaction, for example, whether 3 steps are too few and 6 steps too much, what type of feedback drives improvement (e.g., real time or not, audio, video, text, combinations, and so on), etc. The platform 110 can also let them see demographic and other information that can be leveraged to grow the business.

Platform 110 can also leverage the database information across all trainers and trainees to allow platform administrators to make determinations as to what works and what does not as well as to develop algorithms that can be used to automatically provide feedback that leverage all the trainee information on the platform.

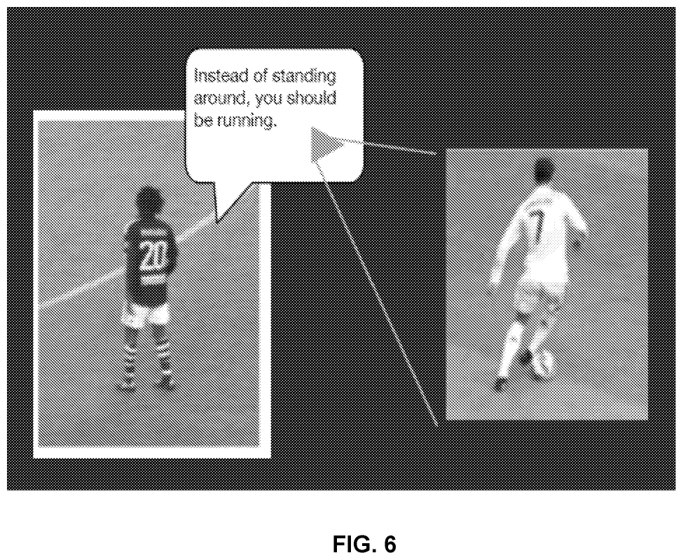

In certain embodiments, the trainer can have the ability, while reviewing the videos to stop a video and provide feedback/comments, for example, video, voice, text annotation (e.g., directly or using audio-to-text program), or written/drawn annotations to the video at key points. In some embodiments, the trainer can also provide feedback/comments while viewing the videos (without stopping or pausing). Application 112 can be configured to analyze the text, audio, or video, and retrieve or develop the appropriate media, such as a text box, audio recording, highlighting, etc., to add to the trainee video or to a captured image form the trainee video. In some embodiments, the application 112 can translate all or some of the trainer feedback to different language(s), change the format of the feedback (e.g., text to voice, voice to text, video to voice, etc.), and/or combine portions of the feedback (e.g., overlay text and video feedback). The annotated video or image can then be saved and made available to the trainee as illustrated in FIG. 6. In some embodiments, some or all of the trainer feedback can additionally, or alternatively, be made available to the trainee via the platform 110 without first overlaying it onto the trainee video/image(s).

In some embodiments, the application 112 can monitor/collect trainer feedback to learn a teaching style of the trainer (for example, by training machine learning algorithm(s) using the feedback). The application 112 may subsequently replicate one or more aspects of the trainer's teaching style (e.g., turns of phrase, types of feedback, specific areas they focus on, etc.) in order to, for example, generate automatic feedback on trainee videos.

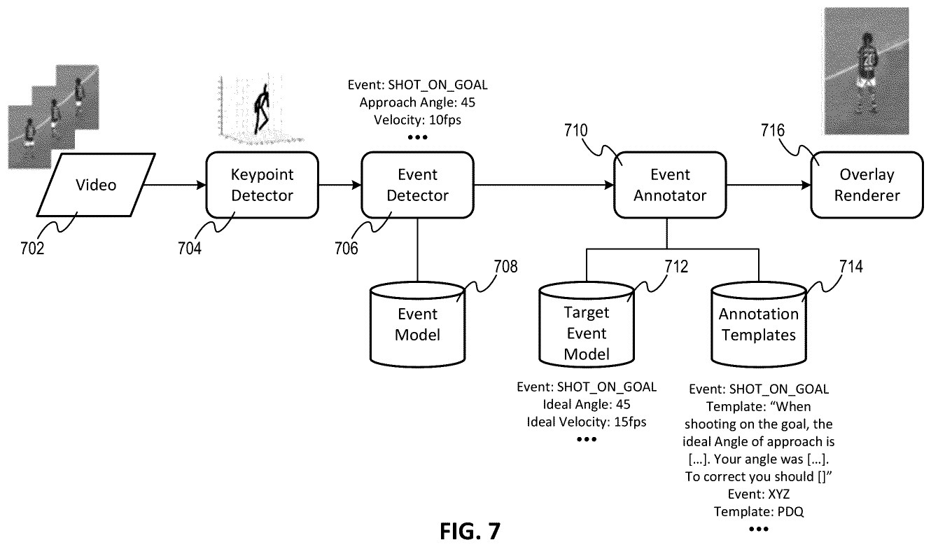

As noted above, in certain embodiments, platform 110 can be configured to perform at least part of the review and analysis of the trainee performance. FIG. 7 a diagram that illustrates an example process for automated feedback in accordance with on embodiment. First, the video 702 is provided to a key point detector 704 that can be implemented via platform 110 and application 112. The key point detector 704 can develop an overlay, for example, using computer vision as explained in more detail below, that can be placed over the image of the individual in the video and used to detect whether the user's body is in the right position (e.g., body parts at appropriate distances/angles to each other/environment/sport equipment; appropriate speed/movement/direction of body parts/equipment) during key events in a movement or skill. Once the overlay is produced, the video with the overlay can be provided to an event detector 706 that can also be implemented via platform 110 and application 112. Event detector 706 can be configured to identify key events, isolate them and then generate key information related to the event based on an event model, which can be stored in database 708 of models. Database 708 can be part of database(s) 114. The models inform event detector 706 as to what should be measured or recorded for the event.

An event annotator 710, which can also be implemented via platform 110 and application 112, can then compare the key information to a target model, which can be stored in a target model database 712. Event annotator 710 can then annotate the video, or images extracted therefrom, with feedback based on the comparison, using an annotation template, which can be stored in an annotation template data base 714. In some embodiments, some of the feedback may be generated to match a particular trainer (e.g., via a machine learning algorithm that has learned the trainer's style). Both target model database 712 and annotation template database 714 can be part of database(s) 114.

An overlay renderer 716, which can be implemented via platform 110 and application 112, can then overlay the annotation on the video or image, which can then be accessed by the trainee.

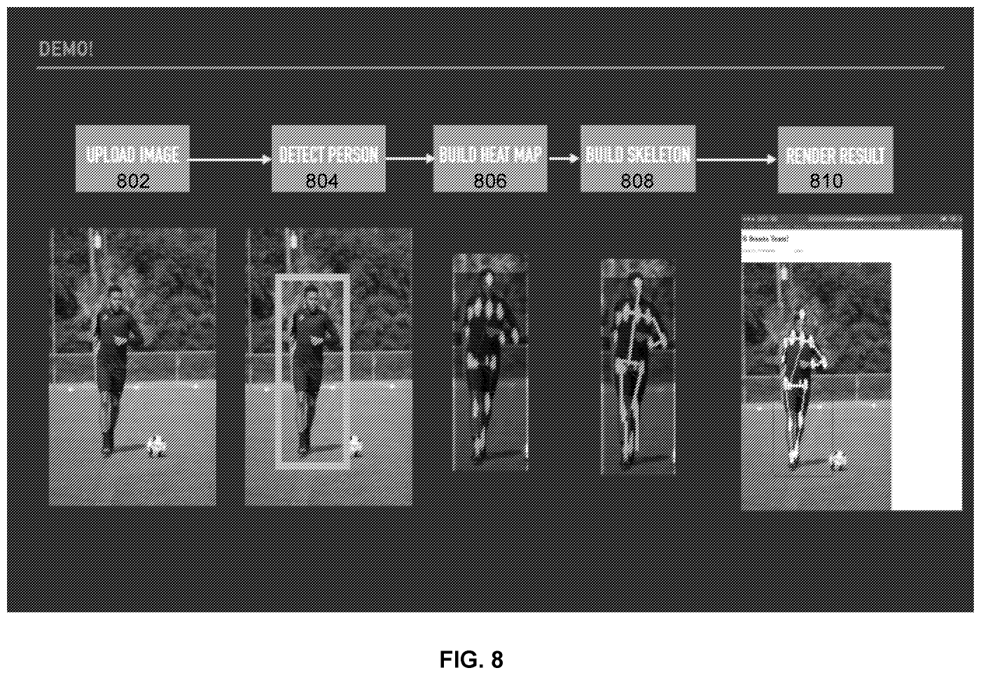

FIG. 8 is a diagram that illustrates an example embodiment for generating an overlay, e.g., via key point detector 704. First, in step 802, the image or video is uploaded. In step 804, the person is detected and isolated. In step 806, a heat map identifying key points on the body is generated. In step 808, the heat spots in the heart map are used to generate a “skeleton” overlay and in step 810, the video or image can be rendered with the overlay so that the event detector 706 and event annotator 719 can perform their functions.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein are therefore representative of the subject matter which is broadly contemplated by the present invention. It is further understood that the scope of the claims and description fully encompasses other embodiments the scope of the present invention is accordingly not limited.

In other embodiments, computer vision can be used to identify a specific player and their movements. For example, players in a soccer game can be tracked individually as they play. This can involve using computer vision to track an individual with in the field of view of the camera. Thus, the computer vision recognizes the individual and then cause the camera to track their movements. Voice or gesture commands can also be used to control the camera(s). In certain embodiments, other sensors or indicators can be attached to the player to enable the computer vision to identify a specific player in a chaotic environment. This can be a simple as a marker that shows up in the video or images and is associated with a specific player. In other embodiments, multiple markers can be attached, e.g., to wrists, ankles, shoulders, head, etc., which not only allow the computer vision to identify a specific player but also aid the computer vision in tracking movement and position of the player.

In other embodiments, or in addition, beacons can be attached to the players. For Example, instead of acting as just a marker, or in addition, the “markers” can be configured to communicate data, e.g., via RFID or other short wave radio communication signals, which can be received and used in conjunction with computer learning to recreate position and movement. Alternatively, or in conjunction, the markers can act as reflectors and sonar can be used to track the makers to help recreate movement and position. Other sensors like accelerometers can be mounted on the players to provide additional data like acceleration, number of steps, etc. Health sensors, such as heart rate sensors, EKG, etc., can also be included and the data there form also used to provide feedback and analysis.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein are therefore representative of the subject matter which is broadly contemplated by the present invention. It is further understood that the scope of the claims and description fully encompasses other embodiments the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C. and any such combination may contain one or more members of its constituents A. B. and/or C. For example, a combination of A and B may comprise one A and multiple B's, multiple A's and one B, or multiple A's and multiple B's.

What is claimed is:

1. An interactive training system comprising:
a user system including a first user interface and second user interfaces;
a processor connected to the first user interface; and
one or more software modules configured to, when executed by the processor:
enable a first user to upload a challenge comprising multiple video segments corresponding to respective multiple steps of the challenge;
enable a plurality of second users to access the challenge via the second user interfaces;
receive trainee videos from the plurality of second users, wherein each of the trainee videos corresponds to a step of the challenge performed by one of the plurality of second users; and
automatically provide feedback on each of the trainee videos;
indicate that a particular second user has mastered a particular step of the challenge; and
based on the indication, authorize the particular second user to access a previously inaccessible video segment of the challenge, the previously inaccessible video segment corresponding to a next step of the challenge.

2. The interactive training system of claim 1, wherein the feedback comprises one or more of: audio, video, text, and visual markups.

3. The interactive training system of claim 1, wherein the one or more software modules are further configured to, when executed by the processor: enable the first user to provide feedback on each of the trainee videos, wherein enabling the first user to provide feedback comprises: enabling the first user to record the feedback while watching one of the trainee videos.

4. The interactive training system of claim 1, wherein the one or more software modules are further configured to, when executed by the processor: generate an annotated trainee video.

5. The interactive training system of claim 4, wherein generating the annotated trainee video comprises: obtaining first feedback of a first trainee video of the trainee videos via the first user interface; generating an annotation based on the first feedback; overlaying the annotation on the first trainee video.

6. The interactive training system of claim 5, wherein the first feedback comprises audio feedback and wherein generating the annotation comprises: converting the audio feedback into text; and inserting text boxes including at least part of the text into relevant parts of the first trainee video.

7. The interactive training system of claim 5, wherein the one or more software modules are further configured to, when executed by the processor: overlay an annotation on a first trainee video by creating a side-by-side comparison of the first trainee video and a corresponding example segment of the multiple video segments; and overlaying the annotation onto the side-by-side comparison.

8. The interactive training system of claim 1, wherein the one or more software modules are further configured to, when executed by the processor: enable the first user to receive, via the first user interface, trainee videos from the plurality of second users, and enable the first user to provide feedback on each of the trainee videos, wherein enabling the first user to receive trainee videos comprises enabling the first user to watch a live video of a trainee; and wherein enabling the first user to provide feedback comprises enabling the first user to provide the feedback live to the trainee.

9. The interactive training system of claim 1, the challenge comprises mastering a physical skill and the multiple steps correspond to separate movements required to master the physical skill.

10. The interactive training system of claim 1, wherein the one or more software modules are further configured to, when executed by the processor: generate an overlay on each of the trainee videos, wherein generating the overlay comprises (i) obtaining the video, (ii) detecting the trainee in the video, (iii) isolating the trainee, (iv) creating a heat map of the trainee, the heat map identifying key points on the trainee; (v) building a skeleton using the heat map; and (vi) rendering the skeleton over the trainee in the video.

11. The interactive training system of claim 10, wherein the one or more software modules are further configured to, when executed by the processor: using the skeleton, compare body positioning and movements of the trainee to body positioning and movement of a model, the model obtained from the training video.

12. The interactive training system of claim 10, wherein the video is of multiple people, and wherein the one or more software modules are further configured to, when executed by the processor: receive sensor data that can be used to identify the trainee; and use computer vision and the sensor data to track the trainee.
